(19) United States
(12) Patent Application Publication
(10) Pub. No.: US 2012/0004957 A1
(43) Pub. Date: Jan. 5, 2012

(54) FORECASTING SUPPLY FOR ADVERTISEMENTS ACCORDING TO A NON-PARAMETRIC SUPPLY MODEL

(75) Inventors: Datong Chen, Santa Clara, CA (US); Erik Vee, San Mateo, CA (US); Jayanth Anandaram, San Francisco, CA (US); Qi He, San Jose, CA (US); Jayavel Shanmugasundaram, Santa Clara, CA (US); Peiji Chen, Saratoga, CA (US)

(73) Assignee: YAHOO! INC., Sunnyvale, CA (US)

(21) Appl. No.: 12/829,593

(22) Filed: Jul. 2, 2010

(51) Int. Cl. G06Q 30/00; G06Q 10/00

(52) U.S. Cl. 705/14.4

(57) ABSTRACT

Methods, systems, and apparatuses for generating supply forecasts for advertisement impressions are provided. Supply forecasts for future advertisement inventory are enabled to be determined that match attribute values received from a requester in a query or “contract.” Such supply forecasts may be determined based on cumulative or non-cumulative supply forecast values, and may be determined based on time series of supply forecast values for individual impressions or for blocks of impressions.

### BACKGROUND OF THE INVENTION

1. Field of the Invention

The present invention relates to online advertising.

2. Background

Online advertisement (“ad”) networks enable display advertisements and/or other types of advertisements to be served to users who visit the Web sites of publishers that are participating in the advertisement network. Advertisers generate the advertisements and buy placements for those advertisements on the publishers' Websites. A placement represents a publisher's agreement to serve a specified advertisement to users when the users visit the publisher's site. The advertisements and placements are typically selected based on the anticipated audiences for those sites. A publisher typically serves the advertisements at the selected placements along with other content associated with the publisher's site.

Each time an advertisement is served to a user, an impression is said to occur.

Each impression has attribute values that indicate information regarding the user to whom the advertisement is served and/or the Web site with which the impression is associated. When an advertiser considers buying placements for an advertisement on a publisher's Website, the advertiser often provides a query or contract to the publisher, requesting an advertising supply forecast. The advertising supply forecast is an estimate of a number of impressions, which are to occur in a future time period, that have specified attribute values. The advertiser typically identifies the specified attribute values in the advertiser's query. For instance, the advertiser may want to target users that have particular attributes (e.g., particular ages, locations, interests, etc.) and/or Websites or publishers that have certain attributes.

Generating a supply forecast for a combination of attribute values received in a query from an advertiser is a computationally extensive process. For example, the number of attributes and corresponding values identified in a query is often substantial, including as many as hundreds or even thousands of attributes. The possible combinations of such attributes are very large in number. Furthermore, hundreds of millions of impression records may need to be analyzed for matching with the query. The analysis may need to be partitioned among multiple servers to reduce the working memory needs on each server. Furthermore, the supply forecast is typically desired to be provided to the advertiser in real time in response to the query. Accordingly, substantial bandwidth and/or resources of a publisher may be consumed to provide a supply forecast in response to the query in a timely manner.

### BRIEF SUMMARY OF THE INVENTION

Various approaches are described herein for, among other things, providing supply forecasts for advertisement impressions. Supply forecasts for future advertisement inventory are enabled to be generated that match attribute values received from a requester in a request that specifies a query or “contract.” Such supply forecasts may be determined based on cumulative or non-cumulative supply forecast values, and may be determined based on time series of supply forecast values for individual impressions or for blocks of impressions. The generated supply forecasts may be provided to the requester in response to the request in a timely manner.

In a first implementation, an advertisement supply forecasting system and method is provided. A user interface is configured to receive a request from a requester for an impression supply forecast based on a contract that indicates at least one attribute and a target time period. A match determiner is configured to determine a plurality of impressions that match the contract. An impression supply forecaster is configured to determine forecasted supplies for the plurality of impressions that match the contract. A forecasted supply summer is configured to sum the determined forecasted supplies to generate an impression supply forecast. The generated impression supply forecast is provided to the requester.

In one implementation, the match determiner is configured to receive an impression-attribute matrix that includes a set of impressions, and indicates one or more attributes of a plurality of attributes satisfied by each impression in the set. The match determiner is configured to apply the at least one attribute of the contract to the impression-attribute matrix to determine any matching impressions in the set of impressions. The determined matching impressions are the impressions determined by the match determiner to match the contract.

In a further implementation, the impression supply forecaster is configured to receive a cumulative forecast value array that includes a time series of cumulative supply forecast values corresponding to each impression of a set of impressions. The impression supply forecaster includes a start time determiner, an end time determiner, and a cumulative value subtractor. The start time determiner is configured to determine a first cumulative supply forecast value in the cumulative forecast value array for a time instance (e.g., a particular day) of a corresponding time series at a start of the target time period. The end time determiner is configured to determine a last cumulative supply forecast value in the cumulative forecast value array for a time instance of a corresponding time series at an end of the target time period. For each impression of the plurality of impressions that match the contract, the cumulative value subtractor is configured to subtract the determined first cumulative supply forecast value from the determined last cumulative supply forecast value to determine a forecasted supply.

In a still further implementation, the impression supply forecaster includes an impression block sorter and an impression block supply calculator. The impression block sorter is configured to sort the plurality of impressions into a plurality of impression blocks. The impression block supply calculator is configured to determine a forecasted supply for each block of the plurality of impression blocks based on a corresponding time series of supply forecast values. The impression block supply calculator multiplies the forecasted supply determined for each block of impressions by a number of impressions included in the block of impressions to generate a corresponding block supply forecast.

In an example implementation of the impression block sorter, the impression block sorter receives a plurality of impression indices that correspond to the plurality of impressions that match the contract. The plurality of impression indices is sorted according to a plurality of impression aggregation bases. The impression block sorter receives an index map that maps one or more impression indices to each of a plurality of aggregation base indices. The impression block sorter includes an aggregation base range determiner and an impression block definer. The aggregation base range determiner is configured to locate in the index map a plurality of first and last impression index pairs to identify ranges of impression indices in the plurality of impression indices that each link to a corresponding aggregation base index. The impression block definer is configured to define a block of impressions for each aggregation base index that has a range of impression indices identified by the aggregation base range determiner Each defined block includes the impressions of the plurality of impressions having indices in the corresponding identified range of impression indices. The impression block supply calculator may be configured to determine a forecasted supply for each block of impressions defined by the impression block definer.

Computer program products are also described herein that enable supply forecasting, and that enable further embodiments as described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement network in accordance with an embodiment described herein.

FIG. 2 shows a block diagram of an advertisement supply forecasting system, according to an example embodiment.

FIG. 3 shows a flowchart for forecasting advertising supply, according to an example embodiment.

FIG. 4 shows a block diagram of a match determiner, according to an example embodiment.

FIG. 5 shows an example impression-attribute matrix, according to an embodiment.

FIG. 6 shows a block diagram of an impression supply forecaster, according to an example embodiment.

FIG. 7 shows an example forecast value array, according to an embodiment.

FIG. 8 shows a block diagram of an impression supply forecaster, according to an example embodiment.

FIG. 9 shows a flowchart for forecasting supply for impressions using cumulative supply forecast values, according to an example embodiment.

FIG. 10 shows an example cumulative forecast value array, according to an embodiment.

FIG. 11 shows a block diagram of an impression supply forecaster, according to an example embodiment.

FIG. 12 shows a flowchart for forecasting supply for impressions using impression blocks, according to an example embodiment.

FIG. 13 shows an example cumulative forecast value array, according to an embodiment.

FIG. 14 shows a block diagram of an impression block sorter, according to an example embodiment.

FIG. 15 shows a flowchart for sorting impressions into impression blocks, according to an example embodiment.

FIG. 16 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

A supply forecast is an estimate of a number of impressions that are to occur in a future time period for a particular set of attribute values. Example embodiments are provided herein for determining a supply forecast for future impression inventory that matches attribute values received from a requester in a query or “contract.” Such embodiments enable supply forecasting to be performed for any number of attribute values more rapidly than conventional techniques. Furthermore, embodiments described herein may consume substantially less bandwidth and/or resources for supply forecasting than conventional techniques. Example advertising environments and embodiments for supply forecasting are described in detail in the following sections.

### II. Example Online Advertising Environment Embodiments

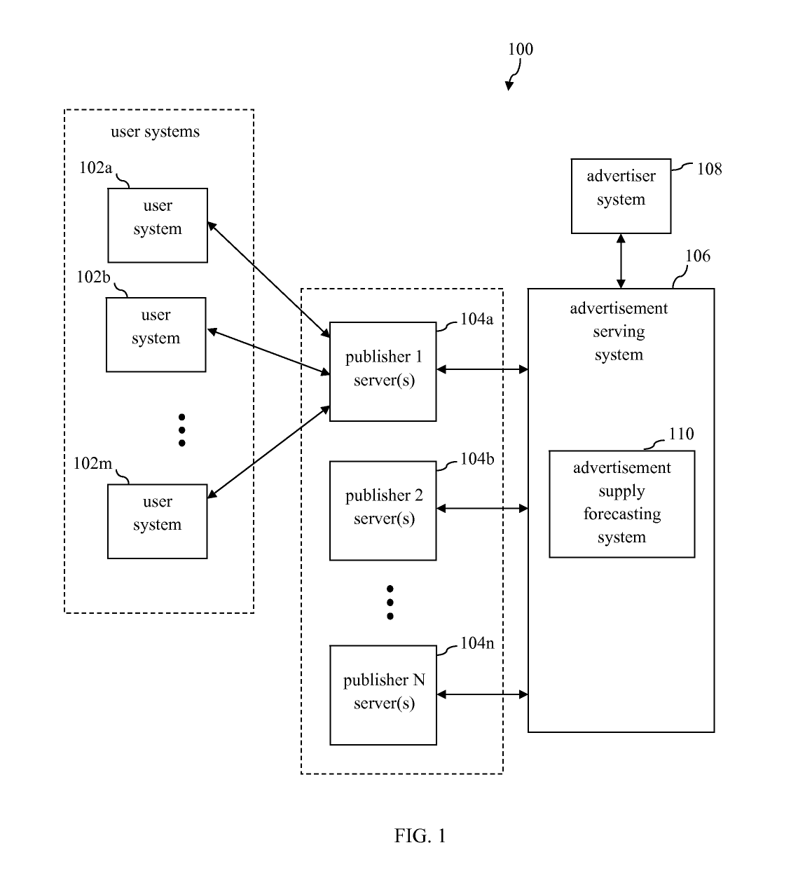

Embodiments for supply forecasting may be implemented in a variety of advertising environments. For instance, FIG. 1 shows a block diagram of an example advertisement (“advertisement”) network 100, according to an embodiment. Advertisement network 100 operates to serve advertisements provided by advertisers, such as display advertisements or other types of advertisements, to publisher sites (e.g., Web sites). When such sites are accessed by users of the network, the advertisements are displayed to the users.

As shown in FIG. 1, display advertisement network 100 includes a plurality of user systems 102a-102m, a plurality of publisher servers 104a-104n, an advertisement serving system 106, and at least one advertiser system 108. Communication among user systems 102a-102m, publisher servers 104a-104n, advertisement serving system 106, and advertiser system 108 is carried out over one or more networks using well-known network communication protocols. Example networks include a personal area network (PAN), a local area network (LAN), a wide-area network (WAN), a combination of networks such as the Internet, etc.

User systems 102a-102m are capable of communicating with any one or more of publisher servers 104a-104n in network 100. For example, each of user systems 102a-102m may include a client that enables a user who owns (or otherwise has access to) the user system to access sites (e.g., websites) that are hosted by publisher servers 104a-104n. For instance, a client may include a web browser, a non-web-enabled client, or may be any other suitable type of client. In FIG. 1, each of user systems 102a-102m is shown in FIG. 1 to be communicatively coupled to publisher 1 server(s) 104a to access a site published by publisher 1. Persons skilled in the relevant art(s) will recognize that each of user systems 102a-102m is capable of connecting to any of publisher servers 104a-104n for accessing the sites hosted thereon.

Publisher servers 104a-104n are capable of communicating with user systems 102a-102m in network 100. Each of publisher servers 104a-104n is configured to host a site (e.g., a website) published by a corresponding publisher 1-N so that such site is accessible to users of network 100 via user systems 102a-102m. Each of publisher servers 104a-104n is further configured to serve advertisement(s) to users of network 100 when those users access a website that is hosted by the respective publisher server.

User systems 102a-102m may each be any type of electronic device configured with web browsing functionality (or other suitable network communication functionality), including a desktop computer (e.g., a personal computer, etc.), a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), or a mobile email device.

Advertisement serving system 106 may receive advertisements from advertiser system 108 and/or other sources. Advertisement serving system 106 is configured to serve the advertisements to publisher servers 104a-104n when the sites hosted by servers 104a-104n are accessed by users, thereby facilitating the delivery of advertisements to the users. Advertisement serving system 106 may be implemented in various ways, including in the form of one or more computing systems, such as one or more servers.

As shown in FIG. 1, advertisement serving system 106 includes an advertisement supply forecasting system 110. Advertisement supply forecasting system 110 is configured to generate an advertising supply forecast in response to a query, contract, or targeting predicate that indicates particular attribute values, and which is received from an entity in network 100. In response to the contract, advertisement supply forecasting system 110 generates an advertising supply forecast that is an estimate of a number of impressions that are to occur with respect to one or more websites/web pages in a future time period, and that have the attribute values indicated in the contract. The contract may be received from any requester, including an advertiser at advertiser system 108 or from another entity. Note that in embodiments, any number of advertiser systems 108 and/or other networked entities may be present in network 100 that are capable of transmitting requests for supply forecasts to advertisement supply forecasting system 110.

Advertisement supply forecasting system 110 is configured to forecast supply for advertisements according to a non-parametric technique. The calculation of eligible supply of a query or contract using a non-parametric model is a time consuming process. Even the non-parametric model may be partitioned across multiple data servers when used to determine a supply forecast in response to a contract. The conventional time cost of such a calculation is n×m, where “n” is a number of impressions that are determined to match the query and “m” is a duration for an advertising campaign that is specified in the query. The number of matching impressions “n” may be large, including in the millions of matching impressions. The value “m” can be any number, and a typical value for “m” is about 100 days. A conventional algorithm for calculating a supply forecast for a query takes about 600 msec. Embodiments described herein can perform a supply forecast determination faster than such conventional techniques (e.g., in the order of 27 to 30 times faster than a conventional algorithm). As such, according to embodiments, advertisement supply forecasting system 110 is capable of serving relatively large number of queries per second (e.g., 25-30 queries/sec in one implementation) on the basis of a non-parametric supply model having a large number of matching impressions (e.g., 200 million impressions in one example).

### III. Example Supply Forecasting Embodiments

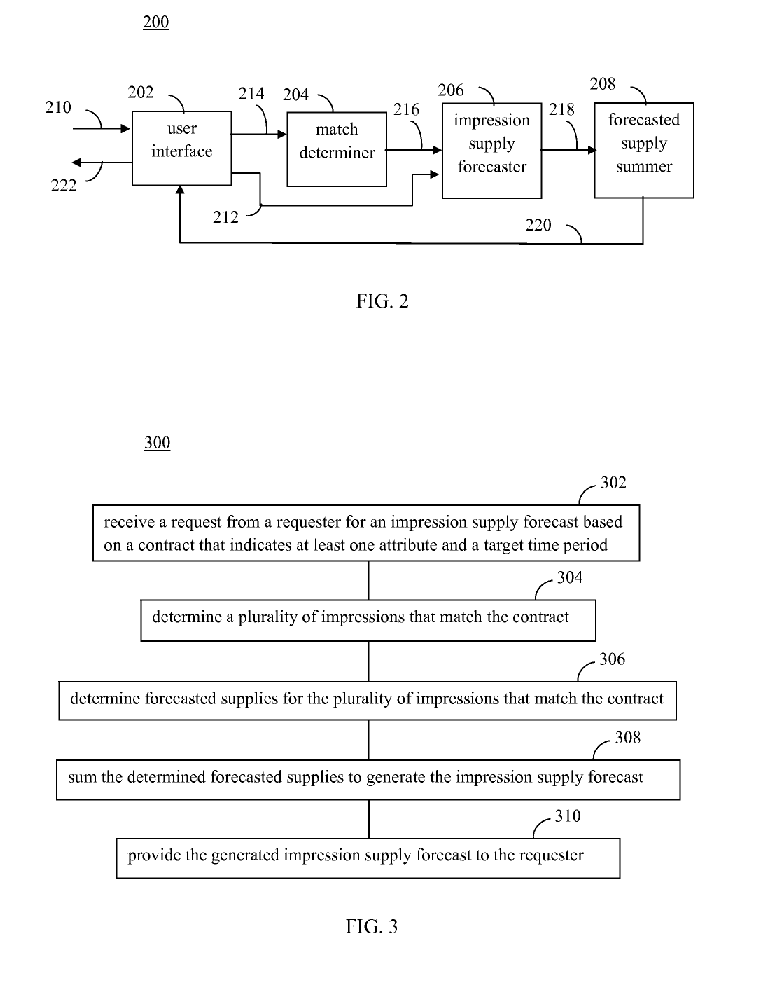

Advertisement supply forecasting system 110 may be implemented in various ways to forecast supply of impressions, in embodiments. For instance, FIG. 2 shows a block diagram of an advertisement supply forecasting system 200, according to an example embodiment. Advertisement supply forecasting system 200 is configured to perform supply forecasting for received contracts. As shown in FIG. 2, advertisement supply forecasting system 200 includes a user interface 202, a match determiner 204, an impression supply forecaster 206, and a forecasted supply summer 208.

Advertisement supply forecasting system 200 is described as follows with respect to FIG. 3. FIG. 3 shows a flowchart 300 for forecasting advertising supply, according to an example embodiment. In an embodiment, advertisement supply forecasting system 200 may operate according to flowchart 300. Further structural and operational embodiments will be apparent to persons skilled in the relevant art(s) based on the discussion regarding flowchart 300. Flowchart 300 and advertisement supply forecasting system 200 are described as follows.

As shown in FIG. 3, flowchart 300 begins with step 302. In step 302, a request is received from a requester for an impression supply forecast based on a contract that indicates at least one attribute and a target time period. For instance, as shown in FIG. 2, user interface 202 receives a supply forecast request 210. Request 210 may be received from any type of requester, including an advertiser (e.g., advertiser system 108 of FIG. 1). Request 210 includes a contract that specifies parameters of the requested supply forecast. For instance, the contract may indicate one or more target online properties (e.g., one or more websites, one or more particular web pages of a website, etc.) at which the requester may desire to display advertisements of an advertising campaign (e.g., a set of advertisements that share a theme to make up an integrated marketing communication). The contract may further indicate one or more attributes associated with advertisement impressions at the indicated target online properties. Such attributes may include demographic attributes associated with a desired target audience, geographic attributes associated with a desired target audience, interests associated with a desired target audience, preferences associated with a desired target audience, and/or further types of attributes that may further define a desired target audience. Still further, the contract may indicate a target time period over which the impressions are desired—the duration of the advertising campaign—in terms of days or other measure of time.

Numerous types of attributes may be specified in a contract. Examples of demographic attributes that may be indicated in a contract include sex (male, female), age (e.g., specific ages, ranges of ages, age categories such as child, teenager, adult, etc.), income, education, employment status, etc. Examples of geographic attributes include present location, home address, home city, home state, home region, home country, etc. Examples of preference attributes include favorite foods, favorite travel destinations, favorite clothes, favorite items such as electronic gadgets, automobiles, etc. Examples of interest attributes include sports, cooking, travel, etc. Any number and combination of these and/or alternative attributes may be specified in a contract, including tens of attributes, hundreds of attributes, thousands of attributes, and even greater numbers of attributes.

User interface 202 may be implemented in any suitable manner to enable supply forecast requests/contracts to be received. For example, in an embodiment, user interface 202 may include a communication interface, such as described elsewhere herein or otherwise known, to receive request 210 in any form, including receiving request 210 as an email, as a text message, etc. In an embodiment, user interface 202 may provide a web page that enables a requester to enter information of request 210 into a fillable form or other graphical user interface. In another embodiment, user interface 202 may be implemented as a web service or other network-based application programming interface (API) configured to receive request 210. As shown in FIG. 2, in response to receiving request 210, user interface 202 outputs attributes 214 and a target time period 212. Attributes 214 includes the attributes indicated in the received contract, which may include the one or more target online properties, demographic attributes, geographical attributes, etc. Target time period 212 is the target time period indicated in the received contract for the advertising campaign.

Referring back to FIG. 3, in step 304, a plurality of impressions that match the contract is determined. For example, as shown in FIG. 2, match determiner 204 receives attributes 214. In an embodiment, match determiner 204 is configured to determine one or more impressions in a set of available impressions (which may number in the hundreds, thousand, millions, etc., of available impressions) that have attributes that match attributes 214. In one embodiment, for an impression of the set of impressions to be a match, each attribute of attributes 214 is fulfilled by the impression. In another embodiment, for an impression of the set of impressions to be a match, a substantial number of the attributes of attributes 214, but not necessarily all attributes, is fulfilled by the impression. As shown in FIG. 2, match determiner 204 generates matching impressions 216. Matching impressions 216 may indicate the matched impressions of the set of available impressions in any form, including as a list of matching impressions, as a list of indices corresponding to the matching impressions, or in any other form. Further example embodiments for step 304 and match determiner 204 are described in further detail below.

In step 306, forecasted supplies are determined for the plurality of impressions that match the contract. For example, as shown in FIG. 2, impression supply forecaster 206 receives matching impressions 216 and target time period 212. In an embodiment, impression supply forecaster 206 is configured to generate a supply forecast for each matching impression of matching impressions 216. For example, impression supply forecaster 206 may reference a forecast value array that indicates a supply forecast for each impression for each day (or other time measure) over a duration of time into the future (e.g., any number of years, such as 3 years). In one embodiment, to determine a supply forecast for a particular impression of matching impressions 216, the forecast value array is referenced to obtain a series of supply forecast values for a number of days covering target time period 212 (e.g., any length of times, such as in weeks or months). The series of supply forecast values are summed together to generate the supply forecast for the impression. Impression supply forecaster 206 may repeat this process for each impression of matching impressions 216 to generate the forecasted supplies. In other embodiments, impression supply forecaster 206 may generate the forecasted supply for each impression of matching impressions 216 in other ways. Further example embodiments for step 306 and impression supply forecaster 206 are described in further detail below. As shown in FIG. 2, impression supply forecaster 206 generates forecasted supplies 218, which includes the forecasted supplies generated for matching impressions 216.

In step 308, the determined forecasted supplies are summed to generate the impression supply forecast. For example, as shown in FIG. 2, forecasted supply summer 208 receives forecasted supplies 218. In an embodiment, forecasted supply summer 208 is configured to sum the forecasted supplies of forecasted supplies 218 to generate an impression supply forecast 220. In one embodiment, forecasted supply summer 208 may receive all of forecasted supplies 218 prior to performing the summation to generate impression supply forecast 220. In another embodiment, forecasted supply summer 208 may include an accumulator. Forecasted supply summer 208 may receive each forecasted supply from impression supply forecaster 206 as it is generated, and accumulator may accumulate each forecasted supply as it is received to performing the summation to generate impression supply forecast 220.

In step 310, the generated impression supply forecast is provided to the requester. For example, as shown in FIG. 2, user interface 202 may receive impression supply forecast 220, and may provide impression supply forecast 220 to the requester in any manner in a supply forecast response 222. For instance, a communication interface of user interface 202 may transmit response 222 to the requester in any form, including as an email, as a text message, etc. In an embodiment, user interface 202 may provide a web page that enables a requester to view response 222. In another embodiment, user interface 202 may be a web service or other network-based API that provides response 222 to the requester.

Impression supply forecast 220 is an impression supply forecast generated for the requester based on the received contract. In an embodiment, impression supply forecast 220 may indicate a number of impressions forecasted to be eligible for supply over the target time period indicated in the contract at the one or more target online properties indicated in the contract. The requester may use the generated supply forecast in any manner, including basing a decision on the generated supply forecast of whether to execute an advertising campaign using the parameters supplied in the contract—the target online properties, attributes, and target time period—or whether to request another supply forecast for another possible advertising campaign. The requester may submit further contracts as subsequent requests 210 based on the information learned from responses 222. The further contracts may be modified relative to previously submitted contracts in any manner to aid the requester in forming an advertising campaign aligned with the requester's advertising campaign goals.

Match determiner 204 and impression supply forecaster 206 may be implemented in various ways to perform their respective functions. Example embodiments for match determiner 204 and impression supply forecaster 206 are described in the following subsections.

### A. Example Match Determiner Embodiments

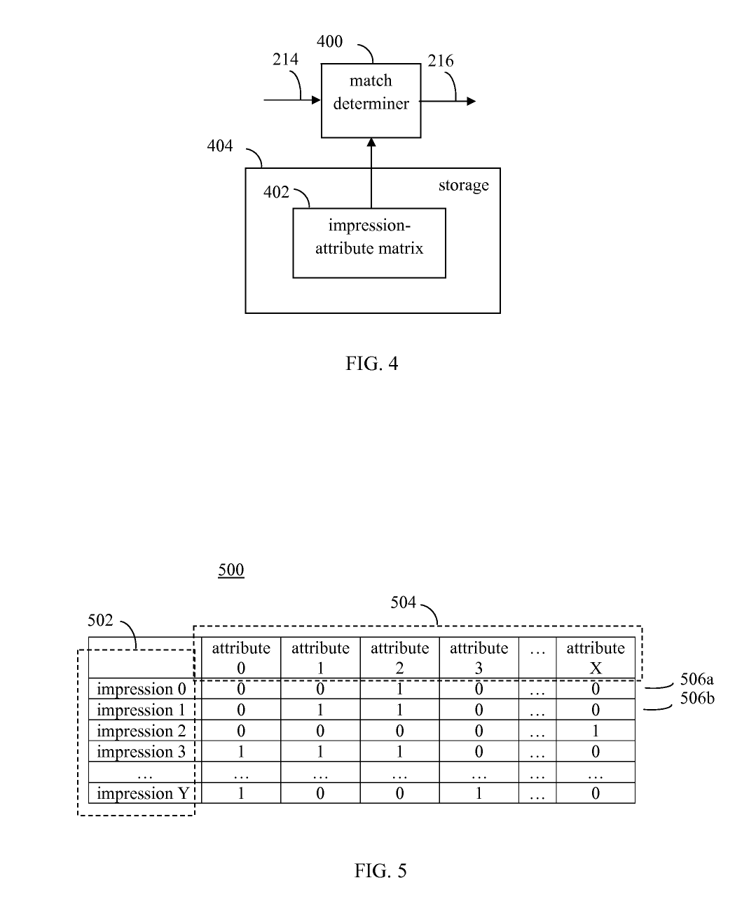

As described above, match determiner 204 of FIG. 2 may be implemented in various ways, and corresponding step 304 of FIG. 3 may be performed in various ways. For instance, FIG. 4 shows a block diagram of a match determiner 400, according to an example embodiment. Match determiner 400 is an example of match determiner 204 of FIG. 2. Similarly to match determiner 204, match determiner 400 is configured to determine one or more impressions in a set of available impressions that have attributes that match attributes 214 (e.g., according to step 304).

As shown in FIG. 4, match determiner 400 receives attributes 214 and an impression-attribute matrix 402. In the example of FIG. 4, impression-attribute matrix 402 is shown stored in storage 404, and is received by match determiner 400 from storage 404. Impression-attribute matrix 402 is a pre-generated matrix (e.g., may be generated prior to a contract being received by a back end portion of advertisement serving system 106 of FIG. 1) that includes a set of impressions and indicates one or more attributes of a plurality of attributes satisfied by each impression in the set. Impression-attribute matrix 402 may be configured in any manner, including in matrix, table, or array form. For example, impression-attribute matrix 402 may be arranged such that the set of impressions is listed along a first matrix axis and attributes for the impression are indicated along a second matrix axis.

For instance, FIG. 5 shows an example impression-attribute matrix 500, according to an embodiment. Impression-attribute matrix 500 is an example of matrix 402 of FIG. 4. As shown in FIG. 5, impression-attribute matrix 500 lists a set of impressions 502 and lists a plurality of attributes 504. Impressions of set of impressions 502 are listed row-by-row in matrix 500, and attributes of attributes 504 are indicated column-by-column in matrix 500. As such, matrix 500 aligns impressions in rows and attributes in columns. Set of impressions 502 in matrix 500 includes impressions 0-Y, and attributes 504 in matrix 500 include attributes 0-X. Y and X can have any values in matrix 500, such that matrix 500 can have any size, including impressions in the numbers of thousands or millions, and attributes in the thousands or millions.

In the embodiment of FIG. 5, matrix 500 is a binary matrix, such that a bit “1” at row i and column j means the ith impression satisfies the attribute of the jth column. A bit “0” at row i and column j means the ith impression does not satisfy the attribute of the jth column. For example, a first row 506a of matrix 500 corresponds to impression 0. As indicated by matrix 500, impression 0 satisfies attribute 2 (and potentially further attributes not visible in FIG. 5), and does not satisfy attributes 0, 1, 3, and X (and potentially further attributes not visible in FIG. 5). A second row 506b of matrix 500 corresponds to impression 1. As indicated by matrix 500, impression 1 satisfies attributes 1 and 2 (and potentially further attributes not visible in FIG. 5), and does not satisfy attributes 0, 3, and X (and potentially further attributes not visible in FIG. 5).

Match determiner 400 of FIG. 4 may be configured to apply attributes 214 of the received contract to impression-attribute matrix 500 in this manner to determine a plurality of matching impressions in set of impressions 502, and to output these matching impressions as matching impressions 216. For example, if attributes 214 includes attribute 2 but not attribute 1, impression 0 of set of impressions may be determined to be a matching impression, while impression 1 is determined to not be a matching impression. Any number of matching impressions may be included in matching impressions 216, including tens, hundreds, thousand, millions, etc., of matching impressions.

In an embodiment, matrix 500 may be organized in a compressed form to support fast look up of matching impressions, while using a relatively small storage space in storage 404. For instance, matrix 500 may be implemented according to the open source “Fastbit” indexing technology, which is an indexing technology that uses a compressed bitmap, and may be configured to generate a list of matching impressions in the form of a list of indices corresponding to the matching impressions (e.g., with reference to matrix 500, may output index “0” for impression 0, index “1” for impression 1, etc.), or in other manner. In other embodiments, matrix 500 may be configured in other ways.

Storage 404 may be any suitable type of storage included in system 200 (FIG. 2), including one or more of a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

### B. Example Impression Supply Forecaster Embodiments

As described above, impression supply forecaster 206 of FIG. 2 may be implemented and step 306 of FIG. 3 may be performed in various ways. The following subsections describe example embodiments for impression supply forecaster 206 and for step 306, including embodiments using non-cumulative forecast values to forecast supply for impressions, embodiments using cumulative forecast values to forecast supply for impressions, and embodiments using blocks of impressions to forecast supply for impressions.

### 1. Example Embodiments for Supply Forecast using Non-Cumulative Forecast Values

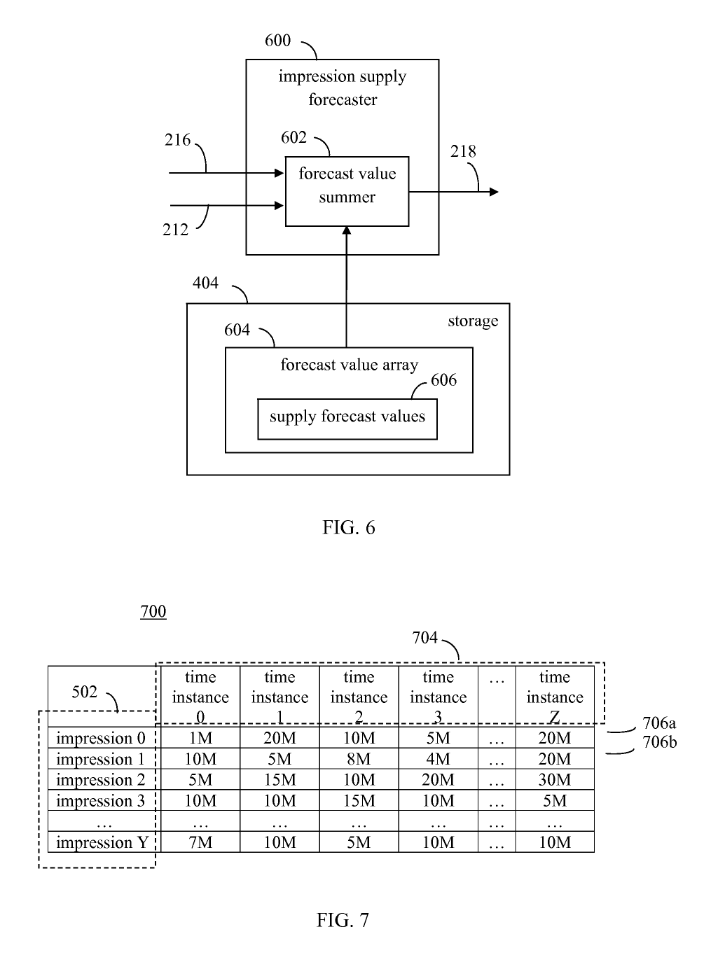

FIG. 6 shows a block diagram of an impression supply forecaster 600, according to an example embodiment. Impression supply forecaster 600 is an example of impression supply forecaster 206 of FIG. 2. Similarly to impression supply forecaster 206, impression supply forecaster 600 is configured to generate a supply forecast for each matching impression of matching impressions 216.

As shown in FIG. 6, impression supply forecaster 600 includes a forecast value summer 602. Forecast value summer 602 receives matching impressions 216, target time period 212, and a forecast value array 604. Forecast value array 604 is shown stored in, and received by forecast value summer 602 from storage 404. Forecast value array 604 includes supply forecast values 606 corresponding to a set of available impressions (e.g., set of impressions 502 in FIG. 5). Each supply forecast value of supply forecast values 606 indicates a forecasted supply of the corresponding impression for a particular time instance. As such, supply forecast values 606 are non-cumulative. For each available impression, forecast value array 604 may include a time series of supply forecast values indicating a forecasted supply of the corresponding impression for each time instance over a period of time (e.g., any number of years, such as 3 years). Forecast value array 604 may be arranged such that the set of impressions is indicated along a first array axis and time instances are indicated along a second array axis.

For instance, FIG. 7 shows an example forecast value array 700, according to an embodiment. Forecast value array 700 is an example of forecast value array 604 of FIG. 6. As shown in FIG. 7, forecast value array 700 lists set of impressions 502 and lists a plurality of time instances 704. Impressions of set of impressions 502 are listed row-by-row in array 700, and time instances of time instances 704 are indicated column-by-column in array 700. As such, array 700 aligns impressions in rows and time instances in columns. Set of impressions 502 in array 700 includes impressions 0-Y, and time instances 704 in array 700 include time instances 0-Z.

In the embodiment of FIG. 7, array 700 contains supply forecast values 606 (FIG. 6) for each listed impression in the form of a time series. A supply forecast value at row i and column j indicates a forecasted supply of impressions for the ith impression on the time instance of the jth column. For example, a first row 706a of array 700 corresponds to impression 0, and provides a time series of supply forecast values for impression 0. As indicated by array 700, impression 0 has a forecasted supply value of 1 million impressions on time instance 0 (e.g., day 0). Array 700 further indicates forecasted supply values for impression 0 of 20 million, 10 million, 5 million, and 20 million impressions for time instances 1, 2, 3, and Z, respectively. Second row 706b of array 700 corresponds to impression 1, and provides a time series of supply forecast values for impression 1. As indicated by array 700, impression 1 has a forecasted supply value of 10 million impressions on time instance 0 (e.g., day 0). Array 700 further indicates forecasted supply values for impression 1 of 5 million, 8 million, 4 million, and 20 million impressions for time instances 1, 2, 3, and Z, respectively. Each further row of array 700 provides a time series of supply forecast values for a subsequent corresponding impression.

Referring to FIG. 6, in one embodiment, to determine a supply forecast for a particular impression of matching impressions 216, impression supply forecaster 600 may obtain the time series of supply forecast values from array 604 for a number of time instances (e.g., days) covering target time period 212. The series of supply forecast values are summed together by forecast value summer 602 to generate the supply forecast for the impression. Impression supply forecaster 206 may repeat this process for each impression of matching impressions 216 to generate the corresponding forecasted supplies. As such, for each impression, impression supply forecaster 600 may perform Equation 1 below:

$$Ti ( ts , te ) = {\sum }_{t = ts}^{te} Vi [ t ] , \qquad Equation 1$$

where

Ti=the supply forecast for matching impression i,

ts=the starting time instance of target time period 212,

te=the ending time instance of target time period 212, and

Vi[t]=a supply forecast value (e.g., from array 604) for matching impression i at time instance t.

For example, referring to FIG. 7, for impression 0, forecast value summer 602 may generate a supply forecast for a target time period 212 of time instance 1 to time instance 3 (e.g., Jan. 10, 2011 through Jan. 12, 2011) to be the sum of 20 million+10 million+5 million=35 million impressions. Likewise, for impression 1, forecast value summer 602 may generate a supply forecast for a target time period 212 of time instance 1 to time instance 3 to be the sum of 5 million+8 million+4 million=17 million impressions.

Thus, in an example where impression 0 and impression 1 are determined to be the matching impressions of matching impressions 216, and impression supply forecaster 206 determines forecasted supplies 218 to include 35 million impressions for impression 0 and 17 million impressions for impression 1, forecasted supply summer 208 of FIG. 2 receives 35 million impressions and 17 million impressions (in forecasted supplies 218), and sums these values to equal 52 million impressions. As a result, forecasted supply summer 208 outputs impression supply forecast 220 as the sum of 52 million impressions.

As such, in an embodiment, forecasted supply summer 208 of FIG. 2 may perform the summation of Equation 2 below to generate impression supply forecast 220:

$$f ( u ) = {\sum }_{MI} Ti ( ts , te ) = {\sum }_{MI} {\sum }_{t = ts}^{te} Vi [ t - t 0 ] , \qquad Equation 2$$

where

f(u)=impression supply forecast 220 for targeting predicate u,

t0=the first time instance, and

MI=all impressions matching targeting predicate u (matching impressions 216).

In Equation 2, the targeting predicate u is the contract received in request 210. A running time Equation 2 is n×m, where “n” is the number of matching impressions and “m” is the number of days in the duration. In some cases, targeting predicate u can result in matching impressions 216 including millions to hundreds of millions of matching impressions, covering a target time period 212 of 1-36 months (30-1000 days), leading to a relatively time consuming determination for impression supply forecast 220.

### 2. Example Embodiments for Supply Forecast using Cumulative Forecast Values

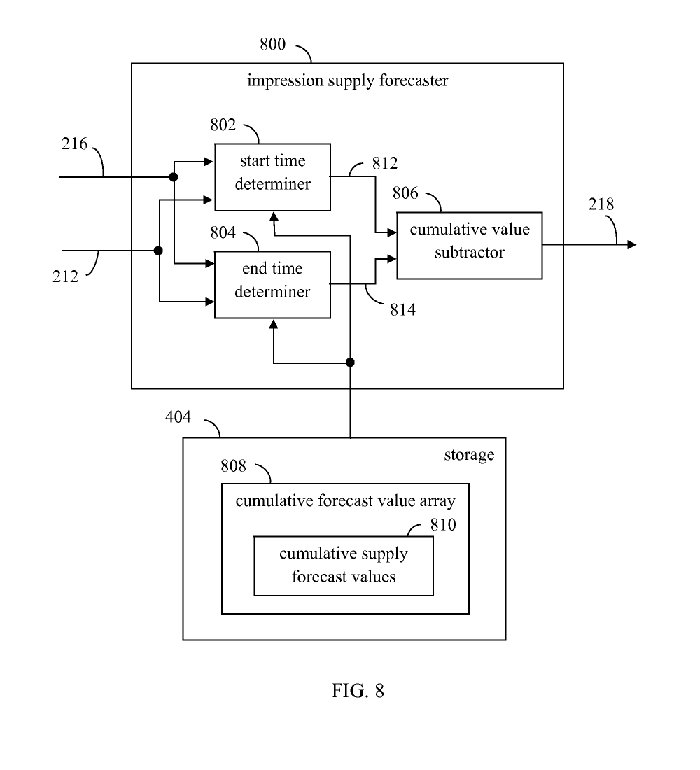

As described above, in other embodiments, impression supply forecaster 206 may generate impression supply forecast 220 in other ways. For instance, FIG. 8 shows a block diagram of an impression supply forecaster 800, according to an example embodiment. Impression supply forecaster 800 is an example of impression supply forecaster 206 of FIG. 2. Similarly to impression supply forecaster 206, impression supply forecaster 800 is configured to generate a supply forecast for each matching impression of matching impressions 216. As described as follows, impression supply forecaster 800 uses cumulative supply forecast values 810 rather than supply forecast values 606, which are non-cumulative. By using cumulative supply forecast values 810, a number of calculations (e.g., summations) may be reduced, enabling a more rapid impression supply forecast to be generated by impression supply forecaster 800.

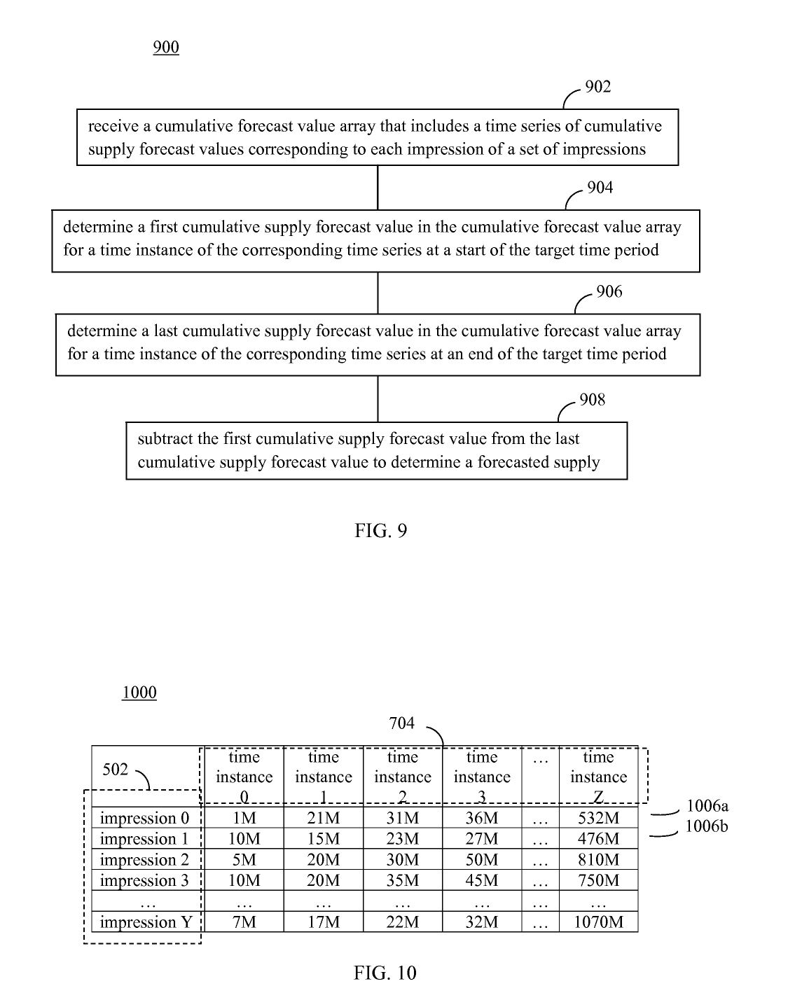

As shown in FIG. 8, impression supply forecaster 800 includes a start time determiner 802, an end time determiner 804, and a cumulative value subtractor 806. Impression supply forecaster 800 is described as follows with respect to FIG. 9. FIG. 9 shows a flowchart 900 for forecasting supply for impressions using cumulative supply forecast values, according to an example embodiment. In an embodiment, impression supply forecaster 800 may operate according to flowchart 900. Further structural and operational embodiments will be apparent to persons skilled in the relevant art(s) based on the discussion regarding flowchart 900. Flowchart 900 and impression supply forecaster 800 are described as follows.

As shown in FIG. 9, flowchart 900 begins with step 902. In step 902, a cumulative forecast value array is received that includes a time series of cumulative supply forecast values corresponding to each impression of a set of impressions. For example, as shown in FIG. 8, impression supply forecaster 800 receives cumulative forecast value array 808. Cumulative forecast value array 808 includes a time series of cumulative supply forecast values corresponding to each impression of a set of impressions. For instance, FIG. 10 shows an example cumulative forecast value array 1000, according to an embodiment. Cumulative forecast value array 1000 is an example of cumulative forecast value array 808 of FIG. 8. As shown in FIG. 10, cumulative forecast value array 1000 lists set of impressions 502 and lists time instances 704. Similarly to array 700 of FIG. 7, impressions of set of impressions 502 are listed row-by-row in array 1000, and time instances of time instances 704 are indicated column-by-column in array 700. As such, array 1000 aligns impressions in rows and time instances in columns.

In the embodiment of FIG. 10, array 1000 contains cumulative supply forecast values 810 (FIG. 8) for each listed impression in the form of a time series. A cumulative supply forecast value at row i and column j indicates a cumulative forecasted supply of impressions for the ith impression from time instance 0 to the time instance of the jth column. For example, a first row 1006a of array 1000 corresponds to impression 0, and provides a time series of cumulative supply forecast values for impression 0 based on the non-cumulative time series shown for impression 0 in array 700 (FIG. 7). As indicated by array 1000, impression 0 has a cumulative forecasted supply value of 1 million impressions at time instance 0 (e.g., day 0), similarly to impression 0 at time instance 0 in array 700. Array 1000 further indicates cumulative forecasted supply values for impression 0 of 21 million, 31 million, 36 million, and 532 million impressions at time instances 1, 2, 3, and Z, respectively. Time instance 1 for first row 1006a is a cumulative supply forecast value of time instance 0 and time instance 1 of row 706a of array 700, where the cumulative forecasted supply value is equal to 1 million+20 million=21 million. Time instance 2 for first row 1006a is a cumulative supply forecast value of time instance 0, time instance 1, and time instance 2 of row 706a of array 700, where the cumulative forecasted supply value is equal to 1 million+20 million+10 million=31 million. Time instance 3 for first row 1006a is a cumulative supply forecast value of time instance 0, time instance 1, time instance 2, and time instance 3 of row 706a of array 700, where the cumulative forecasted supply value is equal to 1 million+20 million+10 million+5 million=36 million. Time instance Z for first row 1006a is a cumulative supply forecast value of time instances 0 through Z, which is shown equal to 532 million in the example of FIG. 10.

In a similar manner, second row 1006b of array 1000 corresponds to impression 1, and provides a time series of cumulative supply forecast values for impression 1 based on the non-cumulative time series shown for impression 1 in array 700. As indicated by array 1000, impression 1 has a cumulative forecasted supply value of 10 million impressions at time instance 0, a cumulative forecasted supply value of 15 million impressions at time instance 1 (10 million+5 million from row 706b of array 700), a cumulative forecasted supply value of 23 million impressions at time instance 2 (10 million+5 million+8 million), a cumulative forecasted supply value of 27 million impressions at time instance 3 (10 million+5 million+8 million+4 million), and a cumulative forecasted supply value of 476 million impressions at time instance Z (for time instances 0-Z in row 706b of array 700). Cumulative forecasted supply values may be determined for subsequent impressions in array 1000 in a similar manner. As such, cumulative forecast value array 808 of FIG. 8 may be pre-generated (e.g., by a back end system of advertisement serving system 106 of FIG. 1) based on forecast value array 604 of FIG. 6.

For instance, referring to FIG. 8, cumulative supply forecast values 810 of array 808 may be calculated by a cumulative supply forecast value generator that receives array 604 including supply forecast values 606 (FIG. 6). For instance, the cumulative supply forecast value generator may perform Equation 3 below to generate each row (corresponding to an impression) of array 1000:

$$CV [ t ] = {\sum }_{x = t 0}^{t} V [ x ] \qquad Equation 3$$

where

CV[t]=cumulative forecast value array 1000 at time instance t, and

V[x]=a supply forecast value at time instance x.

As such, a running time of determining a supply forecast is reduced (relative to the prior subsection) to approximately 2×n (where n=the number of matching impressions). This is because rather than summing together a series of supply forecast values (e.g., using forecast value summer 602 as described above) to generate the supply forecast for an impression, a single subtraction operation may be performed to generate the supply forecast for the impression (as described below with respect to step 908).

In step 904, a first cumulative supply forecast value in the cumulative forecast value array is determined for a time instance of the corresponding time series at a start of the target time period. For example, as shown in FIG. 8, start time determiner 802 receives matching impressions 216, target time period 212, and cumulative supply forecast values 810. For each impression of matching impressions 216, start time determiner 802 is configured to determine a first cumulative supply forecast value in cumulative forecast value array 808 for a time instance of the corresponding time series at a start of target time period 212. For instance, in an embodiment, start time determiner 802 may be configured to determine the first cumulative supply forecast value to be the cumulative supply forecast value in the time series for the impression in array 808 that is immediately prior to the cumulative supply forecast value corresponding to the first day of target time period 212 (e.g., the cumulative supply forecast value at ts −1). As shown in FIG. 8, start time determiner 802 outputs first cumulative supply forecast values 812.

For example, referring to array 1000 of FIG. 10, if the start date of target time period 212 is time instance 1 (e.g., ts=Jan. 10, 2011), and impressions 0 and 1 are included in matching impressions 216, start time determiner 802 determines a first cumulative supply forecast value of 1 million for impression 0 and a first cumulative supply forecast value of 10 million for impression 1 (both at ts −1=Jan. 9, 2011, which is time instance 0 in array 1000).

In step 906, a last cumulative supply forecast value in the cumulative forecast value array is determined for a time instance of the corresponding time series at an end of the target time period. For example, as shown in FIG. 8, end time determiner 804 receives matching impressions 216, target time period 212, and cumulative supply forecast values 810. For each impression of matching impressions 216, end time determiner 804 is configured to determine a last cumulative supply forecast value in cumulative forecast value array 808 for a time instance of the corresponding time series at an end of target time period 212. As shown in FIG. 8, end time determiner 804 outputs last cumulative supply forecast values 814.

For example, referring to array 1000 of FIG. 10, if the end date of target time period 212 is time instance 3 (e.g., te=Jan. 12, 2011), and impressions 0 and 1 are included in matching impressions 216, end time determiner 804 determines a last cumulative supply forecast value of 36 million for impression 0 and a last cumulative supply forecast value of 27 million for impression 1.

In step 908, the first cumulative supply forecast value is subtracted from the last cumulative supply forecast value to determine a forecasted supply. For example, as shown in FIG. 8, cumulative value subtractor 806 receives first cumulative supply forecast values 812 and last cumulative supply forecast values 814. For each impression of matching impressions 216, cumulative value subtractor 806 is configured to subtract first cumulative supply forecast value 812 from last cumulative supply forecast value 814 to determine a forecasted supply. As shown in FIG. 8, cumulative value subtractor 806 outputs forecasted supplies 218, which includes the forecasted supply generated for each impression of matching impressions 216. In such case, cumulative value subtractor 806 may perform Equation 4 below to determine each forecasted supply:

FVi=CVi[te]−CVi[ts−1] Equation 4

where

CVi[t]=the cumulative forecast value for impression i at time t, and

FVi=the supply forecast generated for impression i.

As such, forecasted supply summer 208 of FIG. 2 may perform the summation of the supply forecasts generated by Equation 4 according to Equation 5 below to generate impression supply forecast 220:

$$f ( u ) = {\sum }_{i} FVi \qquad Equation 5$$

For instance, referring to the current example, a first cumulative supply forecast value of 1 million for impression 0 and a first cumulative supply forecast value of 10 million for impression 1 are received in first cumulative supply forecast values 812, and a last cumulative supply forecast value of 36 million for impression 0 and a last cumulative supply forecast value of 27 million for impression 1 are received last cumulative supply forecast values 814. Cumulative value subtractor 806 subtracts 1 million from 36 million to determine a forecasted supply of 35 million impressions for impression 0, and subtracts 10 million from 27 million to determine a forecasted supply of 17 million impressions for impression 1 for a target time period 212 of Jan. 10-12, 2011. Thus, in this example, forecasted supplies 218 include the forecasted supply of 35 million impressions for impression 0 and the forecasted supply of 17 million impressions for impression 1. Forecasted supply summer 208 of FIG. 2 may sum these values received in forecasted supplies 218 to generate impression supply forecast 220.

### 3. Example Embodiments for Supply Forecast using Blocks of Related Impressions

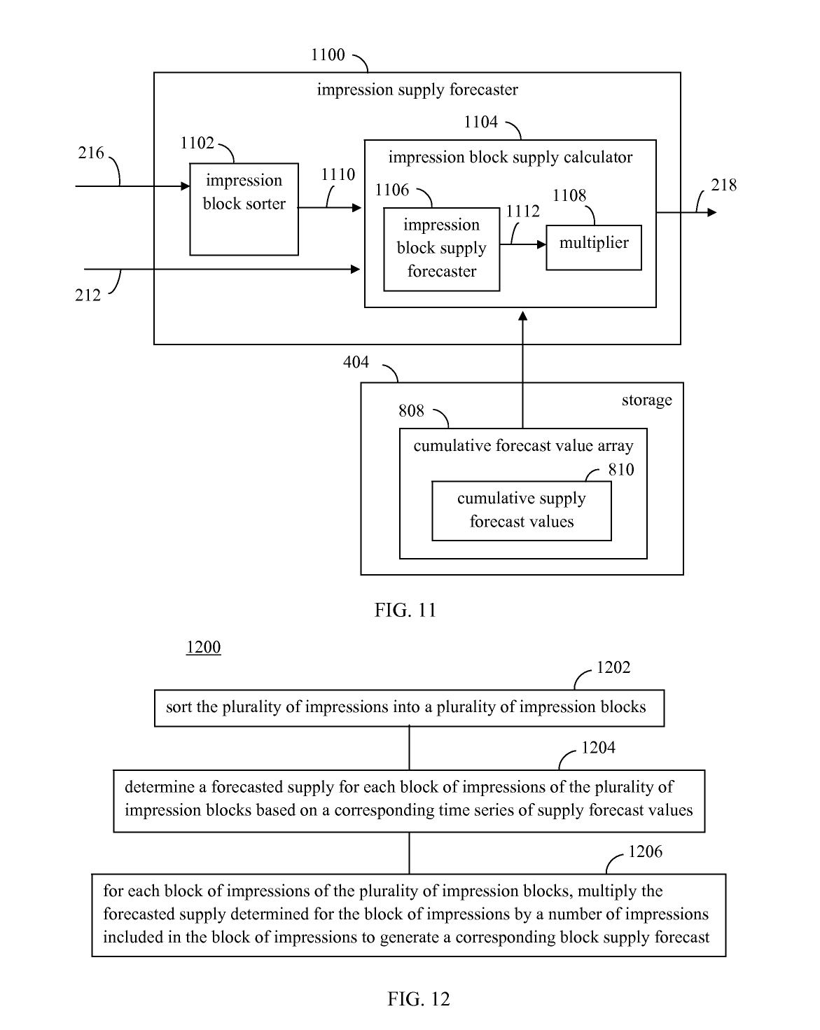

In another embodiment, impression supply forecaster 206 of FIG. 2 may be configured to generate forecasted supplies 218 using groups of impressions, or “impression blocks,” to further reduce a number of calculations. For instance, FIG. 11 shows a block diagram of an impression supply forecaster 1100, according to an example embodiment. Impression supply forecaster 1100 is an example of impression supply forecaster 206 of FIG. 2. Similarly to impression supply forecaster 206, impression supply forecaster 1100 is configured to generate a supply forecast for each matching impression of matching impressions 216. As described as follows, impression supply forecaster 1100 utilizes blocks of impressions having the same time series of supply forecast values (e.g., either cumulative or non-cumulative) to reduce a number of calculations.

As shown in FIG. 11, impression supply forecaster 1100 includes an impression block sorter 1102 and an impression block supply calculator 1104. Furthermore, impression block supply calculator 1104 includes an impression block supply forecaster 1106 and a multiplier 1108. Impression supply forecaster 1100 is described as follows with respect to FIG. 12. FIG. 12 shows a flowchart 1200 for forecasting supply for impressions using impression blocks, according to an example embodiment. In an embodiment, impression supply forecaster 1100 may operate according to flowchart 1200. Further structural and operational embodiments will be apparent to persons skilled in the relevant art(s) based on the discussion regarding flowchart 1200. Flowchart 1200 and impression supply forecaster 1100 are described as follows.

As shown in FIG. 12, flowchart 1200 begins with step 1202. In step 1202, the plurality of impressions is sorted into a plurality of impression blocks. For example, as shown in FIG. 11, impression block sorter 1102 receives matching impressions 216. Impression block sorter 1102 is configured to sort matching impressions 216 into a plurality of impression blocks, where the impressions sorted into a particular impression block are related to each other, and therefore have the same time series of supply forecast values indicating a forecasted supply of the impressions. In embodiments, impressions sorted into a common impression block may be related to each other for various reasons, including being impressions included in a same web page, in a same website, and/or in another type of impression aggregation base. For example, an impression block may include all impressions that reside on a group of websites, a particular website, or a set or collection of web pages of a website (e.g., domain such as a top-level domain, a second-level domain, or other level in a domain hierarchy), such as a www.msnbc.com aggregation base, a www.yahoo.com/finance aggregation base, a www.espn.com/nfl aggregation base, or any other aggregation base.

As shown in FIG. 11, impression block sorter 1102 generates impression blocks 1110, which includes a plurality of impression blocks, and indicates one or more impressions of matched impressions 216 that are included in each block of the plurality of impression blocks.

In step 1204, a forecasted supply is determined for each block of impressions of the plurality of impression blocks based on a corresponding time series of supply forecast values. For example, as shown in FIG. 11, impression block supply calculator 1104 receives impression blocks 1110, target time period 212, and cumulative forecast value array 810. Impression block supply forecaster 1106 may use impression blocks 1110, target time period 212, and cumulative forecast value array 810 to determine a forecasted supply for each block included in impression blocks 1110. As shown in FIG. 11, impression block supply forecaster 1106 generates block supply forecasts 1112, which includes the forecasted supply determined for each block included in impression blocks 1110.

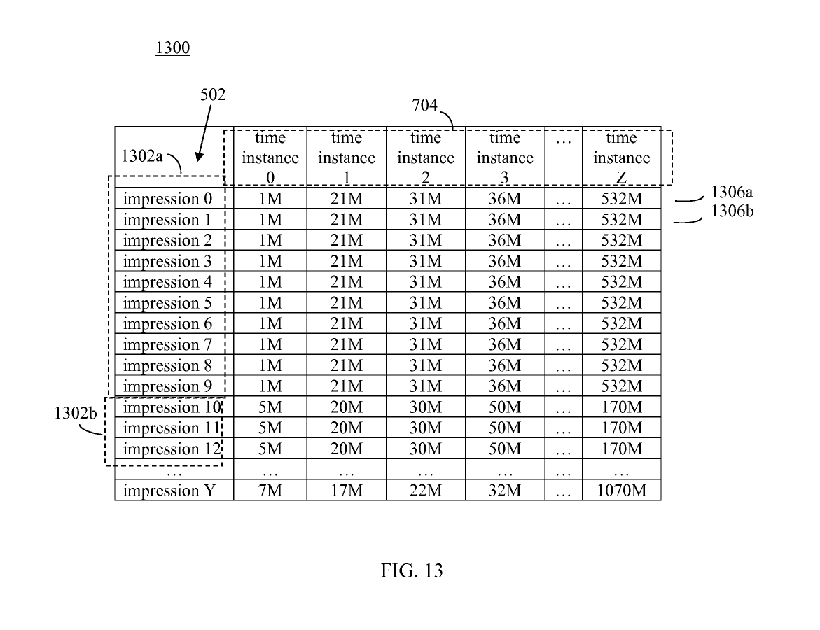

For instance, FIG. 13 shows an example cumulative forecast value array 1300, according to an embodiment. Cumulative forecast value array 1300 is an example of cumulative forecast value array 808 of FIG. 11. As shown in FIG. 13, cumulative forecast value array 1300 lists set of impressions 502 and lists time instances 704. Similarly to array 1000 of FIG. 7, impressions of set of impressions 502 are listed row-by-row in array 1300, and time instances of time instances 704 are indicated column-by-column in array 1300. As such, array 1300 aligns impressions in rows and time instances in columns. Furthermore, similarly to array 1000 of FIG. 10, array 1300 contains cumulative supply forecast values 810 (FIG. 8) for each listed impression in the form of a time series. As such, a cumulative supply forecast value at row i and column j indicates a cumulative forecasted supply of impressions for the ith impression from time instance 0 to the time instance of the jth column.

Still further, array 1300 is arranged such that array 1300 includes a plurality of impression blocks 1302. For instance, a first impression block 1302a is shown in array 1300, and a portion of a second impression block 1302b is shown in array 1300. First impression block 1302a is shown as including ten impressions—impressions 0-9 (three impressions—impressions 10-12 are shown in array 1300 as included in second impression block 1302b, although further impressions may be included in second impression block 1302b). Any number of impression blocks 1302 may be included in array 1300, including hundreds of thousands, millions, or greater numbers of impression blocks 1302. Furthermore, any number of impressions may be included in each impression block 1302, including hundreds, thousands, millions, etc., of impressions. In the embodiment of FIG. 13, impressions that are included in a common impression block 1302 are adjacent and arranged in series in array 1300. As such, impressions included in a common impression block 1302 have a corresponding sequential series of impression indices (e.g., impression indices 0-9 in first impression block 1302a, etc.).

As indicated in array 1300, impressions included in a common impression block 1302 each have the same time series of cumulative supply forecast values. For example, each of impressions 0-9 of first impression block 1302a have the same time series of cumulative supply forecast values (e.g., 1 million impressions at time instance 0, 21 million impressions at time instance 1, 31 million impressions at time instance 2, 36 million impressions at time instance 3, etc.). As such, a forecasted supply may be determined once for the time series of first impression block 1302a to generate a forecasted supply of each of impressions 0-9. The forecasted supply may be generated by impression block supply calculator 1104 of FIG. 11 in any manner, including as described above with respect to flowchart 900 of FIG. 9. For instance, impression blocks 1110 may indicate impression block 1302a, and a target time period 212 of time instances 1-3 may be received. In such case, and with reference to array 1300, a forecasted supply for first impression block 1302a may be generated by subtracting 1 million (first cumulative supply forecast value 812) from 36 million (last cumulative supply forecast value 814) to generate a forecasted supply of 35 million impressions. Block supply forecasts 1112 includes the forecasted supply determined for first impression block 1302a and each further block indicated in impression blocks 1110.

Referring back to FIG. 12, in step 1206, for each block of impressions of the plurality of impression blocks, the forecasted supply determined for the block of impressions is multiplied by a number of impressions included in the block of impressions to generate a corresponding block supply forecast. For example, in an embodiment, multiplier 1108 receives block supply forecasts 1112 and impression blocks 1110. For each impression block 1302 indicated impression blocks 1110, multiplier 1108 is configured to multiply the corresponding block supply forecast of block supply forecasts 1112 by the number of impressions included in the impression block 1302 to determine a total supply forecast for the impression block 1302.

For example, referring to array 1300 of FIG. 13, impression block 1302a includes 10 impressions (impressions 0-9). In one example, matching impressions 216 may include impressions 1, 3, 7, and 8 of impression block 1302a (4 impressions), and block supply forecasts 1112 may indicate a forecasted supply of 35 million impressions for first impression block 1302a. As such, the total supply forecast for impression block 1302a may be calculated by multiplier 1108 as 35 million×4 impressions=350 million impressions. Multiplier 1108 may determine the forecasted supply for each further impression block 1302 indicated in impression blocks 1110 in a similar manner. Impression block supply calculator 1104 outputs the determined total forecasted supplies for all of the impression blocks as forecasted supplies 218. As described above, forecasted supply summer 208 of FIG. 2 may sum these values received in forecasted supplies 218 to generate impression supply forecast 220. As such, in this embodiment, impression supply forecast 220 is determined according to Equation 6 shown below to determine impression supply forecast 220:

$$f ( u ) = {\sum }_{all j , \vert Bj \vert > 0} \vert Bj \vert ( CVj [ te ] - CVj [ ts - 1 ] ) \qquad Equation 6$$

where

Bj=impression block j, and

|Bj|=the number of matching impressions in impression block j.

### i. Example Impression Block Sorter Embodiments

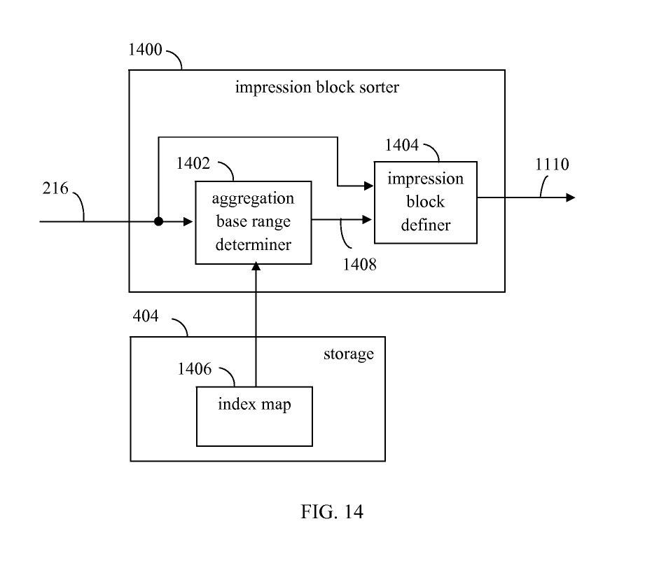

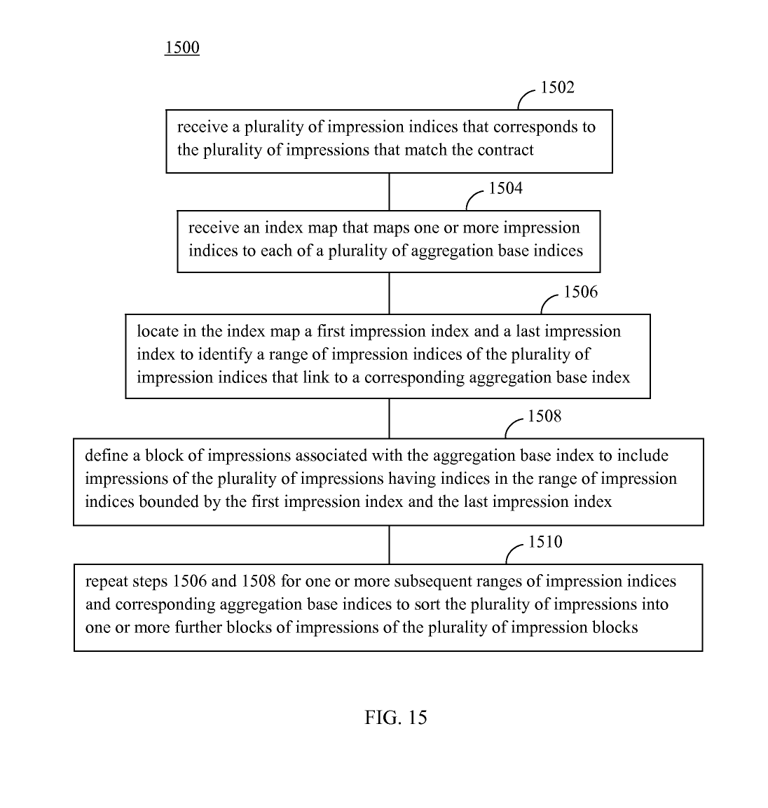

Impression block sorter 1102 may be implemented in various ways to sort impressions into impression blocks. For instance, FIG. 14 shows a block diagram of an impression block sorter 1400, according to an example embodiment. Impression block sorter 1400 is an example of impression block sorter 1102 of FIG. 11. Similarly to impression block sorter 1102, impression block sorter 1400 is configured to sort impressions into impression blocks. As shown in FIG. 14, impression block sorter 1400 includes an aggregation base range determiner 1402 and an impression block definer 1404. Impression block sorter 1400 is described as follows with respect to FIG. 15. FIG. 15 shows a flowchart 1500 for sorting impressions into impression blocks, according to an example embodiment. In an embodiment, impression block sorter 1400 may operate according to flowchart 1500. Further structural and operational embodiments will be apparent to persons skilled in the relevant art(s) based on the discussion regarding flowchart 1500. Flowchart 1500 and impression block sorter 1400 are described as follows.

As shown in FIG. 15, flowchart 1500 begins with step 1502. In step 1502, a plurality of impression indices is received that corresponds to the plurality of impressions that match the contract. For example, as shown in FIG. 14, aggregation base determiner 1402 receives matched impressions 216. In an embodiment, matched impressions 216 indicates impressions determined to match the contract (e.g., in step 304 in FIG. 3) by their respective impression indices, as listed in an impression-attribute matrix such as matrix 402 (FIG. 4) or in other source. For example, as shown in FIG. 5, each impression in set of impressions 502 has a respective index. Matched impressions 216 may indicate the indices of the matched impressions. For instance, if impression 0 and impression 1 are matching impressions, they may be indicated in matched impressions 216 by their respective indices of 0 and 1.

In step 1504, an index map that maps one or more impression indices to each of a plurality of aggregation base indices is received. For example, as shown in FIG. 14, aggregation base range determiner 1402 receives an index map 1406. Index map 1406 is shown stored in storage 404, and is received by aggregation base range determiner 1402 from storage 404 in the example of FIG. 14. Index map 1406 is pre-generated, and indicates a mapping of impression indices to aggregation base indices, to indicate which impressions are related to which aggregation base indices. For example, described above with respect to array 1300 of FIG. 13, impressions 0-9 are in a common impression block 1302a. Index map 1406 may indicate this relation, by mapping impression indices 0-9 to an aggregation base index of 0 (or other appropriate aggregation base index value). Furthermore, index map 1406 may map impression indices 10-100 to an aggregation base index of 1, may map impression indices 101-1,000,000 to an aggregation base index of 2, etc. These example mappings are shown for illustrative purposes in Table 1 below:

TABLE 1
Example Index Map

| Impression | aggregation |
|---|---|
| indices | base index |
| 0-9 | 0 |
| 10-100 | 1 |
| 101-1,000,000 | 2 |
| . . . | . . . |

Index map 1406 may map any number of impressions indices to any number of aggregation base indices, including tens, thousands, or millions of aggregation base indices. Index map 1406 may be configured in any manner.

In step 1506, a first impression index and a last impression index are located in the index map to identify a range of impression indices of the plurality of impression indices that link to a corresponding aggregation base index. For example, in an embodiment, aggregation base range determiner 1402 may be configured to determine a first impression index and a last impression index in index map 1406 for matching impressions indicated in matching impressions 216 that map to a first common aggregation base index. As shown in FIG. 14, aggregation base range determiner 1402 outputs first and last impression indices 1408.

For instance, in one example, matching impressions 216 may include indices for impressions 1, 3, 7, 8, 10, 12, 15, 23, and 87. With respect to the example of index map 1406 provided in Table 1 above, impressions 1, 3, 7, and 8 map to an aggregation base index of 0. Thus, for the first aggregation base index of 0, aggregation base range determiner 1402 may determine a first impression index of 1 and a last impression index of 8 for the impressions indicated in matching impressions 216.

In step 1508, a block of impressions associated with the aggregation base index is defined to include impressions of the plurality of impressions having indices in the range of impression indices bounded by the first impression index and the last impression index. For example, as shown in FIG. 14, impression block definer 1404 receives first and last impression indices 1408 and matching impressions 216. As described above, in an embodiment, matching impressions 216 indicates impression indices for the plurality of impressions that were determined to match the contract. Impression block definer 1404 is configured to define a block of impressions to include impressions of matching impressions 216 that have indices in the range of impression indices indicated by the impression index pair indicated by first and last impression indices 1408. As shown in FIG. 14, impression block definer 1404 outputs impression blocks 1110, which indicates the defined block of impressions.

For instance, continuing the above example, matching impressions 216 includes indices for impressions 1, 3, 7, 8, 10, 12, 15, 23, and 87, and first and last impression indices 1408 indicates first and last impression indices of 1 and 8 for the first aggregation base index of 0. Based on this, impression block definer 1404 defines a first impression block corresponding to the first aggregation base index of 0 that includes impressions of matching impressions 216 having indices in the range of 1 to 8, which are impressions 1, 3, 7, and 8. As shown in FIG. 14, impression block definer 1404 outputs impression blocks 1110, which indicates the defined block of impressions corresponding to the second aggregation base index of 0.

In step 1510, steps 1506 and 1508 are repeated for one or more subsequent ranges of impression indices and corresponding aggregation base indices to sort the plurality of impressions into one or more further blocks of impressions of the plurality of impression blocks. For instance, in further iterations of step 1506, aggregation base range determiner 1402 determines first and last impression index pairs in index map 1406 for further matching impressions indicated in matching impressions 216 that map to a first common aggregation base index. Furthermore, in further iterations of step 1508, impression block definer 1404 defines blocks of impressions that include impressions of matching impressions 216 having indices in the range of impression indices indicated by corresponding impression index pairs indicated by first and last impression indices 1408.

For instance, continuing the above example, matching impressions 216 includes indices for impressions 1, 3, 7, 8, 10, 12, 15, 23, and 87. For the second aggregation base index of 1, aggregation base range determiner 1402 may determine a first impression index of 10 and a last impression index of 87 for the impressions indicated in matching impressions 216. As no further impression indices corresponding to further aggregation base indices are provided in this example of matching impressions 216, aggregation base range determiner 1402 determines no further first and last impression indices. Impression block definer 1404 defines a second impression block corresponding to the second aggregation base index of 1 that includes impressions of matching impressions 216 having indices in the range of 10 to 87, which are impressions 10, 12, 15, 23, and 87. In this example, no further blocks of impressions are defined. As shown in FIG. 14, impression block definer 1404 outputs impression blocks 1110, which indicates the defined block of impressions corresponding to the second aggregation base index of 1.

### C. Example Supply Forecasting Embodiments

The methods and systems described above may be combined in any manner in embodiments for forecasting supply. For instance, flowcharts 300 (FIG. 3), 1200 (FIGS. 12), and 1500 (FIG. 15) may be combined to forecast eligible supply of a targeting predicate “u” according to the embodiment described as follows. This example embodiment may be implemented in hardware, software, firmware, or any combination thereof.

As described above, in an embodiment, the impressions “i” determined to match a targeting predicate may be sorted by their respective aggregation bases (also known as “linking trends”). For example, the Fastbit indexing technology may be utilized generate matching impressions 216 in a manner that maintains the order of impressions, such that the matching impressions of a block Bj are sequentially arranged in matching impressions 216. Matching impressions 216 may be referred to as a matching output list H. H list contains the impression indices of all matching impressions. The impression indices are maintained in order and are grouped by an impression index bi in H. For instance, impression indices b0 to bn that are associated with a first aggregation base are grouped first in H, impression indices bn+1 to bm that are associated with a second aggregation base are grouped second in H, etc. The value ei for each aggregation base, which is the last impression index in matching impressions 216 for an aggregation base, is indicated in index map 1406. The ei values are used to calculate the size of impression block |Bj|, as follows:
(1) The matching list H is determined;
(2) Initialize variables index=0 and totalSupply=0;
(3) While index is not the end of H
   (a) Get index of impression i=H[index],
   (b) Get aggregation base index j=b[i]; b is a map (e.g., index map 1406) from an impression index to its aggregation base index, which may be pre-calculated at a system back end,
   (c) Get index ei of the last impression linking to aggregation base index j from index map 1406. The impression ei may not be a matching impression indicated in matching list H, but all impressions linking to aggregation base j in the matching list H will have indices between i and ei,
   (d) Search the first item H[next]>ei in H,
   (e) Calculate the number of impressions in the block |B|=next−index,
   (f) index=next, and
   (g) accumulate the totalSupply +=|Bj| (CVj[te]−CVj[ts−1]);
(4) Return the total eligible supply totalSupply as the supply forecast in response to the targeting predicate “u”.

Embodiments reduce the number of calculations used to forecast supply, and therefore reduce the amount of time and resources used to forecast supply. For instance, in one example, a supply forecast is generated in 20-22 milliseconds (ms), where determining matching impressions 216 took about 10-12 ms and forecasting supply took about 10 ms, while 600 ms was used to forecast supply according to conventional techniques. As such, in one embodiment, system 200 may serve 25-30 queries/sec in real time on the basis of a non-parametric supply model with 200 million impressions.

### IV. Example Computer Implementations

Advertisement supply forecasting system 110, user interface 202, match determiner 204, impression supply forecaster 206, forecasted supply summer 208, match determiner 400, impression supply forecaster 600, forecast value summer 602, impression supply forecaster 800, start time determiner 802, end time determiner 804, cumulative value subtractor 806, impression supply forecaster 110, impression block sorter 1102, impression block supply calculator 1104, impression block supply forecaster 1106, multiplier 1108, impression block sorter 1400, aggregation base range determiner 1402, and impression block definer 1404 may be implemented in hardware, software, firmware, or any combination thereof. For example, advertisement supply forecasting system 110, user interface 202, match determiner 204, impression supply forecaster 206, forecasted supply summer 208, match determiner 400, impression supply forecaster 600, forecast value summer 602, impression supply forecaster 800, start time determiner 802, end time determiner 804, cumulative value subtractor 806, impression supply forecaster 110, impression block sorter 1102, impression block supply calculator 1104, impression block supply forecaster 1106, multiplier 1108, impression block sorter 1400, aggregation base range determiner 1402, and/or impression block definer 1404 may be implemented as computer program code configured to be executed in one or more processors. Alternatively, advertisement supply forecasting system 110, user interface 202, match determiner 204, impression supply forecaster 206, forecasted supply summer 208, match determiner 400, impression supply forecaster 600, forecast value summer 602, impression supply forecaster 800, start time determiner 802, end time determiner 804, cumulative value subtractor 806, impression supply forecaster 110, impression block sorter 1102, impression block supply calculator 1104, impression block supply forecaster 1106, multiplier 1108, impression block sorter 1400, aggregation base range determiner 1402, and/or impression block definer 1404 may be implemented as hardware logic/electrical circuitry.

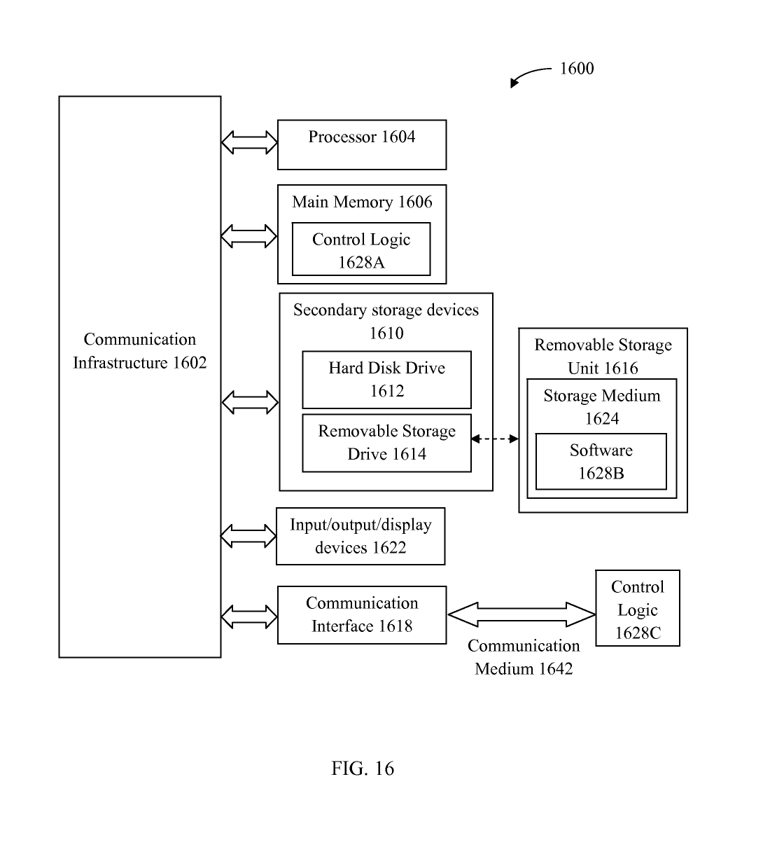

The embodiments described herein, including systems, methods/processes, and/or apparatuses, may be implemented using well known servers/computers, such as a computer 1600 shown in FIG. 16. For example, user systems 102a-102m, publisher servers 104a-104n, advertiser system 108, and/or embodiments of advertisement serving system 106 can be implemented using one or more computers 1600.

Computer 1600 can be any commercially available and well known computer capable of performing the functions described herein, such as computers available from International Business Machines, Apple, Sun, HP, Dell, Cray, etc. Computer 1600 may be any type of computer, including a desktop computer, a server, etc.

Computer 1600 includes one or more processors (also called central processing units, or CPUs), such as a processor 1604. Processor 1604 is connected to a communication infrastructure 1602, such as a communication bus. In some embodiments, processor 1604 can simultaneously operate multiple computing threads.

Computer 1600 also includes a primary or main memory 1606, such as random access memory (RAM). Main memory 1606 has stored therein control logic 1628A (computer software), and data.

Computer 1600 also includes one or more secondary storage devices 1610. Secondary storage devices 1610 include, for example, a hard disk drive 1612 and/or a removable storage device or drive 1614, as well as other types of storage devices, such as memory cards and memory sticks. For instance, computer 1600 may include an industry standard interface, such a universal serial bus (USB) interface for interfacing with devices such as a memory stick. Removable storage drive 1614 represents a floppy disk drive, a magnetic tape drive, a compact disk drive, an optical storage device, tape backup, etc.

Removable storage drive 1614 interacts with a removable storage unit 1616. Removable storage unit 1616 includes a computer useable or readable storage medium 1624 having stored therein computer software 1628B (control logic) and/or data. Removable storage unit 1616 represents a floppy disk, magnetic tape, compact disk, DVD, optical storage disk, or any other computer data storage device. Removable storage drive 1614 reads from and/or writes to removable storage unit 1616 in a well known manner.

Computer 1600 also includes input/output/display devices 1622, such as monitors, keyboards, pointing devices, etc.

Computer 1600 further includes a communication or network interface 1618. Communication interface 1618 enables the computer 1600 to communicate with remote devices. For example, communication interface 1618 allows computer 1600 to communicate over communication networks or mediums 1642 (representing a form of a computer useable or readable medium), such as LANs, WANs, the Internet, etc. Network interface 1618 may interface with remote sites or networks via wired or wireless connections.

Control logic 1628C may be transmitted to and from computer 1600 via the communication medium 1642.

Any apparatus or manufacture comprising a computer useable or readable medium having control logic (software) stored therein is referred to herein as a computer program product or program storage device. This includes, but is not limited to, computer 1600, main memory 1606, secondary storage devices 1610, and removable storage unit 1616. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for advertisement supply forecasting system 110, user interface 202, match determiner 204, impression supply forecaster 206, forecasted supply summer 208, match determiner 400, impression supply forecaster 600, forecast value summer 602, impression supply forecaster 800, start time determiner 802, end time determiner 804, cumulative value subtractor 806, impression supply forecaster 110, impression block sorter 1102, impression block supply calculator 1104, impression block supply forecaster 1106, multiplier 1108, impression block sorter 1400, aggregation base range determiner 1402, impression block definer 1404, flowchart 300, flowchart 900, flowchart 1200, and/or flowchart 1500 (including any one or more steps of flowcharts 300, 900, 1200, and 1500), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
receiving a request from a requester for an impression supply forecast based on a contract that indicates at least one attribute and a target time period;
determining a plurality of impressions that match the contract;
determining forecasted supplies for the plurality of impressions that match the contract;
summing the determined forecasted supplies to generate the impression supply forecast; and
transmitting the generated impression supply forecast to the requester.

2. The method of claim 1, wherein said determining a plurality of impressions that match the contract comprises:
receiving an impression-attribute matrix that includes a set of impressions and indicates one or more attributes of a plurality of attributes satisfied by each impression in the set; and
applying the at least one attribute of the contract to the impression-attribute matrix to determine a plurality of matching impressions in the set of impressions, the plurality of matching impressions being the plurality of impressions determined to match the contract.

3. The method of claim 1, wherein said determining forecasted supplies for the plurality of impressions that match the contract comprises:
receiving a cumulative forecast value array that includes a time series of cumulative supply forecast values corresponding to each impression of a set of impressions; and
for each impression of the plurality of impressions that match the contract,
determining a first cumulative supply forecast value in the cumulative forecast value array for a time instance of the corresponding time series at a start of the target time period,
determining a last cumulative supply forecast value in the cumulative forecast value array for a time instance of the corresponding time series at an end of the target time period, and
subtracting the first cumulative supply forecast value from the last cumulative supply forecast value to determine a forecasted supply.

4. The method of claim 3, wherein each time instance is a day.

5. The method of claim 1, wherein said determining forecasted supplies for the plurality of impressions that match the contract comprises:
sorting the plurality of impressions into a plurality of impression blocks;
determining a forecasted supply for each block of impressions of the plurality of impression blocks based on a corresponding time series of supply forecast values; and
for each block of impressions of the plurality of impression blocks, multiplying the forecasted supply determined for the block of impressions by a number of impressions included in the block of impressions to generate a corresponding block supply forecast such that a plurality of block supply forecasts corresponding to the plurality of impression blocks are generated.

6. The method of claim 5, wherein said summing the determined forecasted supplies to generate the impression supply forecast comprises:
summing the generated plurality of block supply forecasts to generate the impression supply forecast.

7. The method of claim 5, wherein said sorting the plurality of impressions into a plurality of impression blocks comprises:
receiving a plurality of impression indices obtained from an impression-attribute matrix and that correspond to the plurality of impressions that match the contract, the plurality of impression indices being sorted according to a plurality of impression aggregation bases;
receiving an index map that maps one or more impression indices to each of a plurality of aggregation base indices;
locating in the index map a first impression index and a last impression index to identify a range of impression indices of the plurality of impression indices that link to a corresponding aggregation base index;
defining a block of impressions associated with the aggregation base index to include impressions of the plurality of impressions having indices in the range of impression indices bounded by the first impression index and the last impression index; and
repeating said locating and said defining for one or more subsequent ranges of impression indices and corresponding aggregation base indices to sort the plurality of impressions into one or more further blocks of impressions of the plurality of impression blocks.

8. An advertisement supply forecasting system, comprising:
a user interface configured to receive a request from a requester for an impression supply forecast based on a contract that indicates at least one attribute and a target time period;
a match determiner configured to determine a plurality of impressions that match the contract;
an impression supply forecaster configured to determine forecasted supplies for the plurality of impressions that match the contract; and
a forecasted supply summer configured to sum the determined forecasted supplies to generate the impression supply forecast;
wherein the generated impression supply forecast is provided to the requester.

9. The system of claim 8, wherein the match determiner is configured to receive an impression-attribute matrix that includes a set of impressions and indicates one or more attributes of a plurality of attributes satisfied by each impression in the set; and
wherein the match determiner is configured to apply the at least one attribute of the contract to the impression-attribute matrix to determine a plurality of matching impressions in the set of impressions, the plurality of matching impressions being the plurality of impressions determined by the match determiner to match the contract.

10. The system of claim 8, wherein the impression supply forecaster is configured to receive a cumulative forecast value array that includes a time series of cumulative supply forecast values corresponding to each impression of a set of impressions;
wherein the impression supply forecaster includes a start time determiner, an end time determiner, and a cumulative value subtractor;
wherein for each impression of the plurality of impressions that match the contract, the start time determiner is configured to determine a first cumulative supply forecast value in the cumulative forecast value array for a time instance of the corresponding time series at a start of the target time period;
wherein for each impression of the plurality of impressions that match the contract, the end time determiner is configured to determine a last cumulative supply forecast value in the cumulative forecast value array for a time instance of the corresponding time series at an end of the target time period; and
wherein for each impression of the plurality of impressions that match the contract, the cumulative value subtractor is configured to subtract the first cumulative supply forecast value from the last cumulative supply forecast value to determine a forecasted supply.

11. The system of claim 10, wherein each time instance is a day.

12. The system of claim 8, wherein the impression supply forecaster comprises:
an impression block sorter configured to sort the plurality of impressions into a plurality of impression blocks; and
an impression block supply calculator configured to determine a forecasted supply for each block of impressions of the plurality of impression blocks based on a corresponding time series of supply forecast values, and for each block of impressions of the plurality of impression blocks, is configured to multiply the forecasted supply determined for the block of impressions by a number of impressions included in the block of impressions to generate a corresponding block supply forecast such that a plurality of block supply forecasts corresponding to the plurality of impression blocks are generated.

13. The system of claim 12, wherein the forecasted supply summer is configured to sum the generated plurality of block supply forecasts to generate the impression supply forecast.

14. The system of claim 12, wherein the impression block sorter receives a plurality of impression indices that correspond to the plurality of impressions that match the contract, the plurality of impression indices being sorted according to a plurality of impression aggregation bases;
wherein the impression block sorter further receives an index map that maps one or more impression indices to each of a plurality of aggregation base indices;
wherein the impression block sorter comprises an aggregation base range determiner and an impression block definer;
wherein the aggregation base range determiner is configured to locate in the index map a plurality of first and last impression index pairs to identify ranges of impression indices in the plurality of impression indices that each link to a corresponding aggregation base index; and
wherein the impression block definer is configured to define a block of impressions for each aggregation base index that has a range of impression indices identified by the aggregation base range determiner, each defined block including the impressions of the plurality of impressions having indices in the corresponding identified range of impression indices.

15. A computer program product comprising a computer-readable medium having computer program logic recorded thereon for enabling a processor to forecast impression supply, comprising:
first computer program logic means for enabling the processor to determine a plurality of impressions that match a contract received in a request for an impression supply forecast, the contract indicating at least one attribute and a target time period;
second computer program logic means for enabling the processor to determine forecasted supplies for the plurality of impressions that match the contract; and
third computer program logic means for enabling the processor to sum the determined forecasted supplies to generate the impression supply forecast;
wherein the generated impression supply forecast is transmitted to the requester.

16. The computer program product of claim 15, wherein said first computer program logic means comprises:
fourth computer program logic means for enabling the processor to apply the at least one attribute of the contract to an impression-attribute matrix that that includes a set of impressions and indicates one or more attributes of a plurality of attributes satisfied by each impression in the set, the fourth computer program logic means determining a plurality of matching impressions in the set of impressions, the plurality of matching impressions being the plurality of impressions determined to match the contract.

17. The computer program product of claim 15, wherein a cumulative forecast value array is received that includes a time series of cumulative supply forecast values corresponding to each impression of a set of impressions, wherein said second computer program logic means comprises:
fourth computer program logic means for enabling the processor to determine for each impression of the plurality of impressions that match the contract a first cumulative supply forecast value in the cumulative forecast value array for a time instance of the corresponding time series at a start of the target time period;
fifth computer program logic means for enabling the processor to determine for each impression of the plurality of impressions that match the contract a last cumulative supply forecast value in the cumulative forecast value array for a time instance of the corresponding time series at an end of the target time period; and
sixth computer program logic means for enabling the processor to subtract, for each impression of the plurality of impressions that match the contract, the first cumulative supply forecast value from the last cumulative supply forecast value to determine a forecasted supply.

18. The computer program product of claim 15, wherein said second computer program logic means comprises:
fourth computer program logic means for enabling the processor to sort the plurality of impressions into a plurality of impression blocks;
fifth computer program logic means for enabling the processor to determine a forecasted supply for each block of impressions of the plurality of impression blocks based on a corresponding time series of supply forecast values; and
sixth computer program logic means for enabling the processor to multiply, for each block of impressions of the plurality of impression blocks, the forecasted supply determined for the block of impressions by a number of impressions included in the block of impressions to generate a corresponding block supply forecast, such that a plurality of block supply forecasts corresponding to the plurality of impression blocks are generated.

19. The computer program product of claim 18, wherein said third computer program logic means comprises:
seventh computer program logic means for enabling the processor to sum the generated plurality of block supply forecasts to generate the impression supply forecast.

20. The computer program product of claim 18, wherein a plurality of impression indices obtained from an impression-attribute matrix and that correspond to the plurality of impressions that match the contract is received, the plurality of impression indices being sorted according to a plurality of impression aggregation bases, and wherein an index map is received that maps one or more impression indices to each of a plurality of aggregation base indices, said fourth computer program logic means comprises:
seventh computer program logic means for enabling the processor to locate in the index map a plurality of first and last impression index pairs to identify ranges of impression indices in the plurality of impression indices that each link to a corresponding aggregation base index; and
eighth computer program logic means for enabling the processor to define a block of impressions for each aggregation base index that has a range of impression indices identified by the seventh computer program logic means, each defined block including the impressions of the plurality of impressions having indices in the corresponding identified range of impression indices.
